(19) United States
(12) Patent Application Publication
(10) Pub. No.: US 2004/0205531 A1
(43) Pub. Date: Oct. 14, 2004

(54) Method and application for developing a statement of work

(76) Inventors: Bruce Donald Innes, West Chester, OH (US); Robert John Hemmelgarn, Mason, OH (US); Joseph Dominic Gargiulo, Milford, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/932,789

(22) Filed: Aug. 17, 2001

(51) Int. Cl. G06F 17/30

(52) U.S. Cl. 715/507

(57) ABSTRACT

An application is used to assist an engineer with the creation, editing, storing and submission of a statement of work for an engineering project to be completed by an external or global source. The application is used by the engineers to create, edit and store standard statements of work for global sources, to create, edit and store preliminary or draft statements of work for internal use and to create, edit and store “blanket” statements of work that cover a broad work scope of several small projects over a longer period of time. In addition, the application can be used to audit a standard or blanket statement of work and any related documents and technical data for content and compliance with export and business controls before the statement of work is submitted to a global source.

### BACKGROUND OF THE INVENTION

The present invention relates generally to an application for creating a statement of work. More specifically, the present invention is directed to a web based application for assisting a user generate, edit, store and transmit statement of work documents.

A statement of work is used to describe the scope of a project and sets forth the specific tasks that need to be completed by an engineer or other personnel for that project. The scope and tasks in a statement of work can relate to engineering design, analysis, and testing work or to any other similar type of work. The statement of work can also be supplemented with attachments that can be used to provide the engineer with detailed technical information and data that are related to the specific tasks in the statement of work. The engineer uses the statement of work to know what the engineer's responsibilities are for a particular project and to determine what the engineer has to generate or provide under the project.

Frequently, a company or organization may want to use an external source to complete an engineering project. The external source can be located within the United States, but can also be located outside of the United States. The decision to use an external source may be based on economic considerations, on the expertise of the external source or for any other of a number of reasons. An increase in the quantity of engineering projects that are being transferred to external sources by a company or organization results in the introduction of additional risk factors associated with project quality and compliance for that company. One way to ensure project quality and compliance when using external sources is to have a consistent, common format for the statement of work to assure proper interpretation of the project and quality results from the external source.

Previously, each department or division in the company or organization had its own document template in a word processing program for creating a statement of work. The statement of work from each department was frequently customized to the preferences and requirements of that particular department and did not consider the requirements or needs of the external source. This resulted in confusion in the interpretation of the statement of work by the external source because the external source frequently receives statements of work from several different departments in the organization with some items in the statement of work having different meanings depending on the department in the organization that has created the statement of work. In addition, each department stored the prepared statements of work in a different location from those of another department. The separate storage of the statements of work by each department can make it difficult to locate original statements of work at a later time to resolve disputes about the work being performed by the external source.

Therefore, what is needed is an application and process that is available company-wide for assisting a user to electronically create, store, edit and transmit statement of work documents and any additional documents, information or data that are required for a work project.

### SUMMARY OF THE INVENTION

One embodiment of the present invention is directed to a method of providing a statement of work to an external source. The method includes the step of creating an initial statement of work in a predetermined format. The predetermined format of the initial statement of work has a plurality of sections. A project to be completed by the external source is then associated with the initial statement of work. Information is entered into at least one section of the plurality of sections of the initial statement of work to generate a project statement of work. The information entered into the initial statement of work pertains to the project associated with the initial statement of work. The project statement of work is then stored in a database. The method also includes the steps of auditing the project statement of work and transmitting a link to the external source having a location of the project statement of work in the database. Finally, the external source can access the project statement of work with the transmitted link.

Another embodiment of the present invention is directed to a system for providing a statement of work to an external source. The system includes a server computer and at least one client computer in communication with the server computer. The server computer has a storage device and a processor. The system also has a statement of work application to provide a statement of work for a project to an external source. The statement of work application is stored in the storage device of the server computer and is accessible on the at least one client computer. The statement of work application includes a database, a statement of work template, a submission wizard and a technical data wizard. The database stores information pertaining to the project and the statement of work. The statement of work template has a predetermined format with a plurality of fields. The statement of work template is also configured for entry of information into a statement of work for a project. The submission wizard is used to evaluate a statement of work for completeness and to provide a statement of work to the external source. The technical data wizard is used to designate technical data associated with a statement of work.

One advantage of the present invention is that engineering productivity is improved by reducing the cycle time to create statements of work through the use of automation and automatic insertion of previously entered information.

Another advantage of the present invention is that the interpretation of the statements of work by external sources is improved because of the use of a common format, which results in a reduction in errors and restarts.

Still another advantage of the present invention is that it improves productivity and reduces errors by auditing the statement of work for all required inputs and then alerts the user when information is missing.

Yet another advantage of the present invention is that multiple, related small jobs can be placed and documented in a single “blanket” statement of work without the need for a separate statement of work for each job.

A further advantage of the present invention is that an entire work package including a statement of work, related documents and any technical information can be checked for compliance with any export, business or intellectual property controls before being sent electronically to an external source.

Still a further advantage of the present invention is that all statements of work and related documents and information are stored in a common database for easy retrieval by authorized users.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a new statement of work type selection web page.

FIG. 2 illustrates a new draft statement of work type selection web page.

FIG. 3 illustrates a statement of work format selection web page.

FIGS. 4 and 5 illustrate portions of a statement of work template for the entry of information by a user into the body of a statement of work.

FIG. 6 illustrates a web page for adding attachments to a statement of work.

FIG. 7 illustrates a web page for designating files to be attached to a statement of work.

FIG. 8 illustrates a web page for designating line items to be attached to a blanket statement of work.

FIG. 9 illustrates a flow chart of the review procedure for submission of a statement of work.

FIG. 10 illustrates a report web page with details on the statement of work.

FIG. 11 illustrates another embodiment of the tab interface for the SOW application.

FIG. 12 illustrates a technical data tab interface.

FIG. 13 illustrates a technical data list web page.

FIG. 14 illustrates a recipient list web page.

FIG. 15 illustrates a transaction status web page.

FIG. 16 illustrates a printable statement of work web page.

FIG. 17 illustrates a send technical data web page for a user.

FIG. 18 illustrates a get technical data web page for an external source.

Whenever possible, the same reference numbers will be used throughout the figures to refer to the same parts.

### DETAILED DESCRIPTION OF THE INVENTION

The present invention is directed to an application for assisting a user with the creation, editing, storing and transmission, submission or accessibility of a statement of work (SOW) for a project. Preferably, the SOW application or wizard is used by engineers for the generation and submission of statements of work associated with an engineering project. However, the present invention can be used with any type of project that requires a statement of work for completion of the project. The SOW application is used by the engineers to create and store standard statements of work for external sources, create and store preliminary or draft statements of work for internal use and to create and store “blanket” statements of work that cover a broad work scope of several small projects or tasks for an external source over a longer period of time. In addition, the SOW application can be used to edit any information in an existing statement of work and can also be used to audit a standard or blanket statement of work and any related documents and technical data for content and compliance with export, business and company controls before being submitted to an external source.

In another embodiment of the present invention, the SOW application can be incorporated as a component of a larger application that is executed within the larger application. The SOW application can again be used to create, edit, store and submit statements of work, however, the generation, storing and submission or accessibility of statements of work is now included as a portion of the larger application. The SOW application's formatting and storage of statements of work and related information is accomplished in a manner that can be interpreted and understood by the larger application. The larger application can then retrieve and use the statements of work and related information from the SOW application in other operations of the larger application. For example, the larger application may incorporate information from the statement of work into a report or scorecard that is generated by the larger application.

In a preferred embodiment of the present invention, the SOW application is implemented as a network application that is executed in a web browser of the user or engineer. The SOW application can be executed on the client-side, the server-side or on both the client-side and the server-side. Preferably, the SOW application is stored on a server computer and then accessed by the users on client computers. The SOW application also has one or more databases that are used to store the statements of work and related information and documents. The SOW databases are also preferably stored on the server computer and accessed by the users on client computers. In another embodiment, each client computer on the computer network may store an individual copy of the SOW application and the corresponding SOW databases for the individual SOW applications can be stored on either a server computer or one or more of the client computers accessible by each client computer.

The computer network is preferably an Intranet, however any other type of network can also be used, for example, the Internet, a local area network (LAN), a wide area network (WAN) or an Extranet. The client computer and server computer can be any type of general purpose computer having memory or storage devices (e.g. RAM, ROM, hard disk, CD-ROM, etc.), processing units (e.g. CPU, ALU, etc.) and input/output devices (e.g. monitor, keyboard, mouse, printer, etc.). The general purpose computer may also have communication devices (e.g. modems, network cards, etc.) for connecting or linking the general purpose computer to other computers.

In another embodiment of the present invention, the SOW application can be executed without any requirement for a network connection. The SOW application can be executed from an internal memory or storage device, e.g. RAM, ROM, hard disk, etc., of the computer of the user in either a web browser as discussed above or in an operating system environment, such as a Windows environment, a Linux environment or a Unix environment. The SOW application can be loaded into the internal memory of the user's computer from a portable medium such as a CD-ROM, DVD-ROM, floppy disk, etc., that is inserted into the computer. Alternatively, the SOW application can be transferred or loaded directly into the internal memory of the user's computer through an electronic connection with another computer that has a stored copy of the SOW application. In other words, the SOW application can be downloaded to the user's computer from another computer over a network connection or an Internet connection and then be operated without the network connection. The user is able to use the SOW application without a network connection and is able to store the statements of work and related information and documents in a database. However, for other users to be able to have access to the statements of work and related information and documents, the user has to reestablish a network connection and upload any statements of work and related information and documents into the common SOW database that can be accessed by all users.

A user begins the process for generating a statement of work by deciding to create a new project statement of work (PSOW) or a new draft statement of work (DSOW). The PSOW can include blanket statements of work, standard statements of work or any other type of statement of work that is to be provided to an external source. The DSOW is similar to a PSOW, however the DSOW is not intended for an external source and is typically used internally for review and development purposes. As will be discussed in greater detail below, the DSOW can be converted into a PSOW that is provided to the external source by submission or transmission of the PSOW to the external source or by providing the external source with access to the PSOW.

To begin creating either a new PSOW or a new DSOW, the user has to access the SOW application either directly on the Intranet or through the larger application such as a project management application. To create a new DSOW the user access the SOW application before the selection of a project and is limited in the options that are available to the user. A more detailed description of the generation of the DSOW and its corresponding limitations will be provided below. To create a new PSOW, the user has to select a project before accessing the SOW application or select a project immediately after accessing the SOW application.

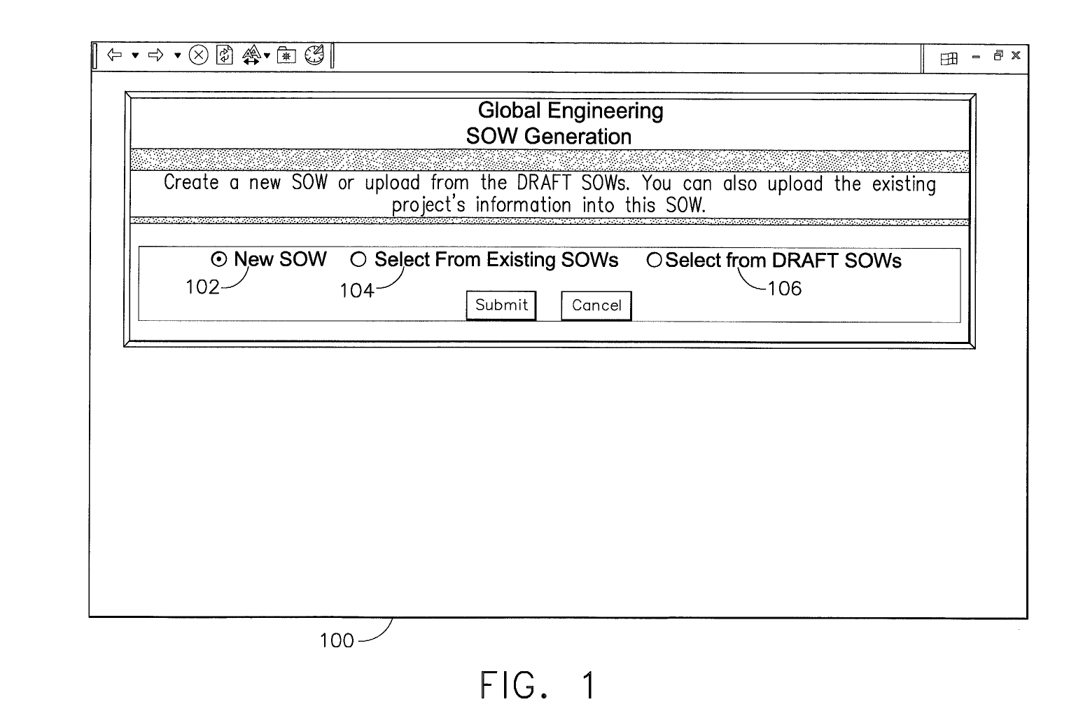

Next, after a project has been selected for the new PSOW, the user has to choose between creating an original statement of work for the new PSOW or basing the new PSOW on an existing PSOW or DSOW. To make this choice for the new PSOW, the user is typically linked or connected to a web page, window or pop-up box that presents the user with several different options for the initial version of the new PSOW. It is to be understood that any reference to a web page of the SOW application can refer equally to a window, pop-up box or other similar type of display technique depending on the specific implementation of the SOW application. FIG. 1 illustrates a web page 100 that presents the user with several options for the creation of an initial version of the new PSOW. In the initial PSOW web page 100, the user can select an option 102 to create a new or original statement of work that is not based on any prior or existing statements of work. The user can also select option 104 to load an existing PSOW stored in a central database or option 106 to load an existing DSOW stored in a central database for use as the basis for the new PSOW.

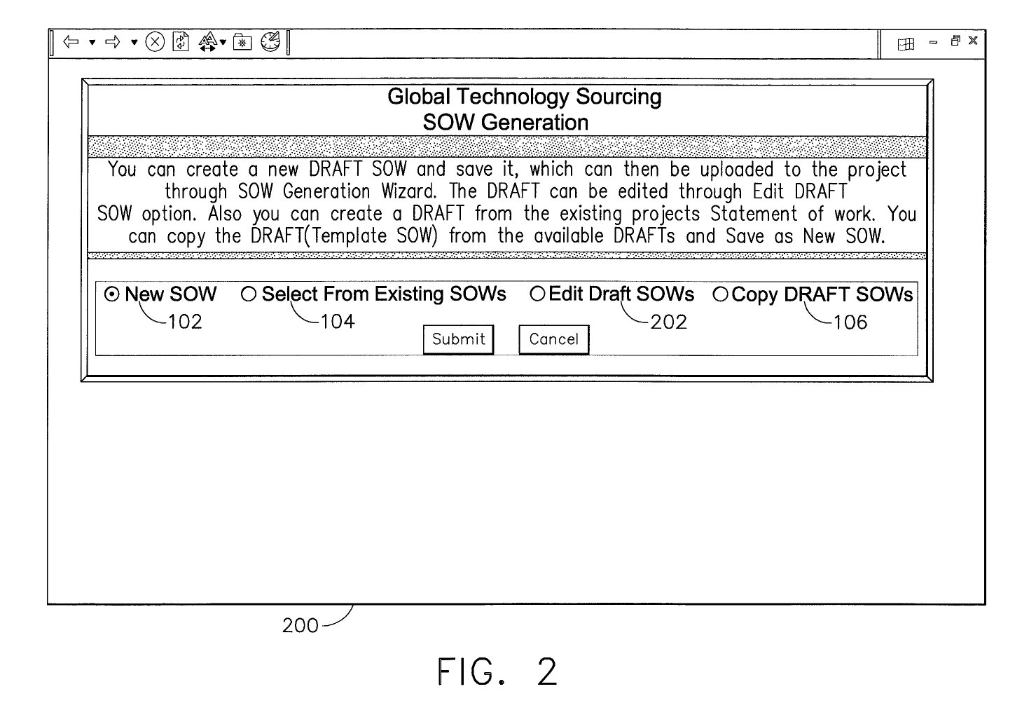

Alternatively, if the user has decided to create a new DSOW, the user follows a process similar to that described above for the creation of a new PSOW, except that the DSOW is not associated with a corresponding project. The user can decide to create an original statement of work for the new DSOW or can decide to modify an existing PSOW or DSOW for the new DSOW. FIG. 2 illustrates a web page 200 that presents the user with several options for the creation of an initial DSOW. On initial DSOW web page 200, the user can again select option 102 to create an original statement of work for the new DSOW, option 104 to load an existing PSOW to be the basis for the new DSOW or option 106 to load an existing DSOW to be the basis for the new DSOW. The user also has the ability to select option 202 from the initial DSOW web page 200 which permits the user to edit an existing DSOW.

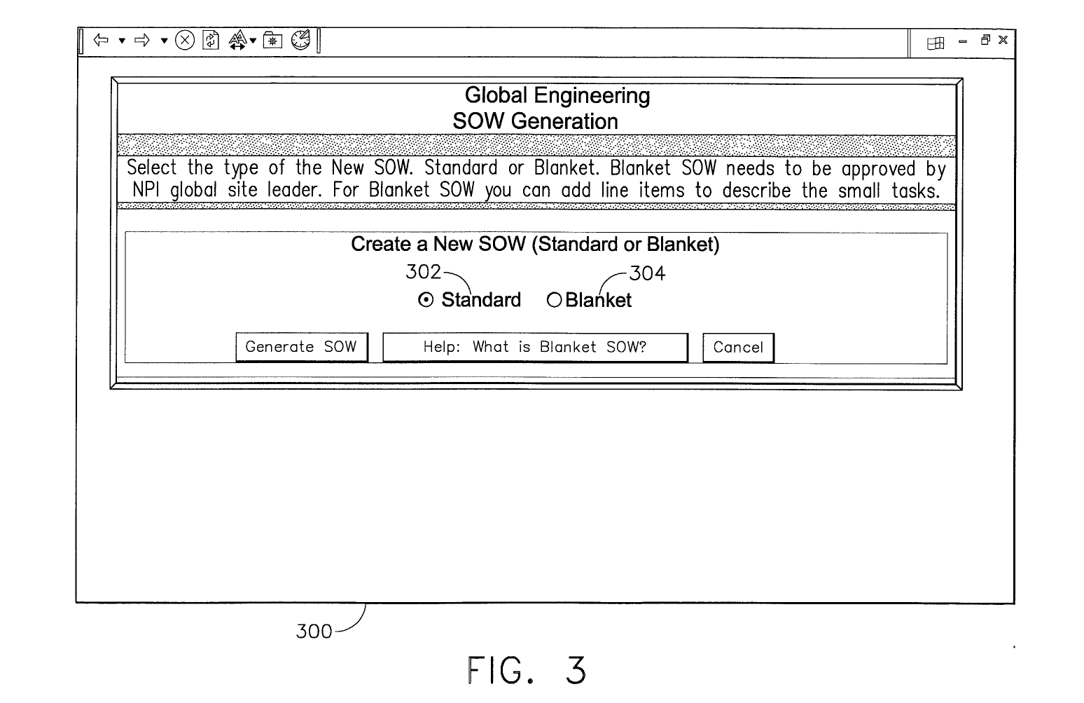

By selecting original statement of work option 102 from either initial DSOW web page 200 or initial PSOW web page 100, the user is then connected, linked or presented with a web page or window for the user to select the format of the new DSOW or PSOW. FIG. 3 illustrates a web page 300 for the selection of the format for the new DSOW or PSOW. On format selection web page 300, the user can select an option 302 for creating a standard statement of work or an option 304 for creating a blanket statement of work. As discussed above, the blanket statement of work typically covers multiple, repetitive jobs or tasks over a relatively long period of time. The jobs or tasks in a blanket statement of work do not have to have any specific relationship to one another and are usually only related to one another by using the same project information when the blanket statement of work is a PSOW. The blanket statement of work can include a series of line items for specific short term jobs (e.g. a job usually requiring under 20 hours of time for completion), jobs that do not have or do not require a definite timeline for completion, or jobs that do not require significant amounts of funding. The user can enter several line items and an associated completion time for each line item (if necessary) into the blanket statement of work. The user can return to the blanket statement of work at a later time and add and edit line items as appropriate.

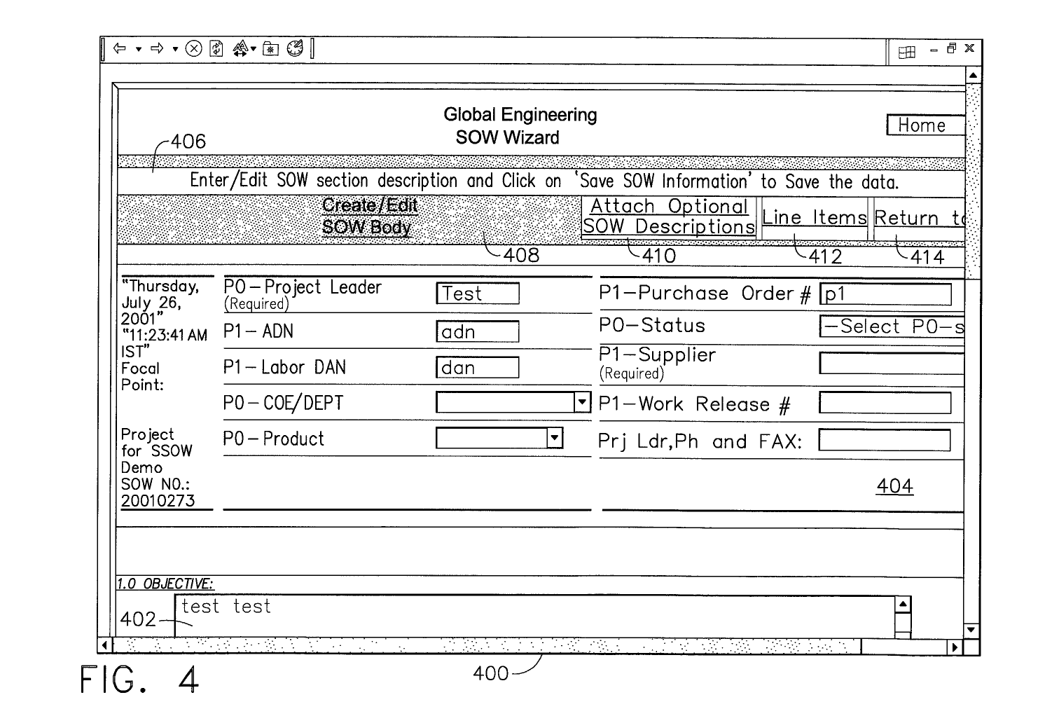

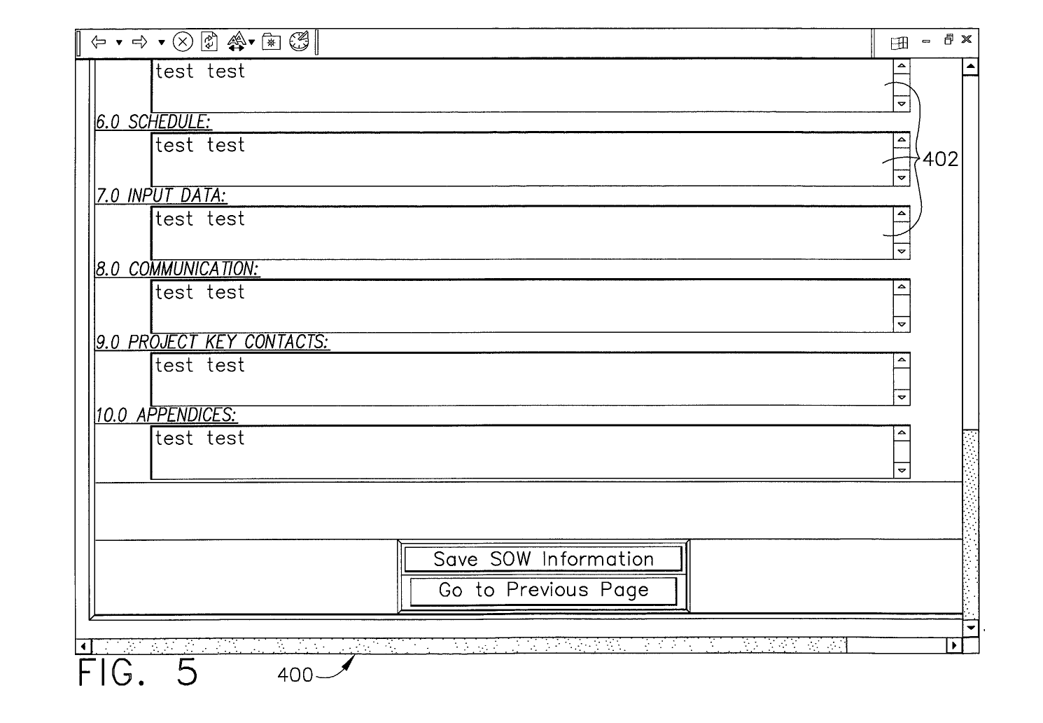

Once the user has selected the format for the new DSOW or PSOW, the user is then connected to a web page or window for the user to complete the body of the statement of work, which preferably has a predetermined format. FIGS. 4 and 5 illustrate portions of a web page 400 that includes a template for the user to complete the body of the new PSOW or DSOW. The template included in SOW body web page 400 has several different fields or sections 402 for the user to supply or edit information in the body of the new DSOW or PSOW. The fields 402 in the template can be configured as HTML fields, as word processing fields or as any other similar type of field. Fields 402, whether configured as HTML fields or as word processing fields, can include word processing options such as type formatting, paragraph formatting and spellcheck, for the user. The field type of fields 402 in the template determines the format of the resultant file after the user has completed entering information into the fields 402 of the template, e.g. HTML fields result in the generation of an HTML file and word processing fields result in the generation of a word processing file.

The template from SOW body web page 400 includes fields 402 for each of the different sections that are included in either a DSOW or a PSOW. The PSOW or DSOW typically includes sections relating to objectives, descriptions, requirements, methodologies, deliverables, schedules, input data, communication, contacts and any additional information or appendices. However, the sections included in the template for the PSOW or DSOW can be varied by adding sections, deleting or removing sections or substituting sections. If the user is creating an original statement of work for the new PSOW or DSOW, the user can enter information into each of the fields 402 that form the body of the PSOW or DSOW. However, if the user is creating a new PSOW or DSOW from an existing PSOW or DSOW, the user then only has to add, delete or modify information as appropriate from the information that was included in the body of the existing PSOW or DSOW. In other words, the difficulty of the process of creating a new PSOW or DSOW is dependent on what option the user selected from initial PSOW web page 100 or initial DSOW web page 200. If the user started with an existing PSOW or DSOW, much of the information required for the new PSOW or DSOW may already have been provided from the existing PSOW or DSOW and the user may only have to make minor changes to the information in fields 402 to complete the new PSOW or DSOW. However, if the user decided to create an original PSOW or DSOW, the user has to enter all of the information into fields 402 to complete the new body of the PSOW or DSOW.

Some of the fields 402 in the template in SOW body web page 400 may be designated as mandatory or required fields. A user will then be prevented from submitting a PSOW to an external source until the mandatory fields have been completed on SOW body web page 400. If the user is creating a new DSOW, the requirements for entering information into fields 402 of the template from SOW body web page 400 can be relaxed or waived.

Furthermore, if a user is creating a blanket statement of work instead of a standard statement of work, the user will have to enter or edit information in fields 402 to form the body of the blanket statement of work, similar to what a user has to complete for a standard statement of work. In addition, the user will have to enter or edit information and allotted time for each of the line items that is to be included in the blanket statement of work. The entering of information relating to line items is described in greater detail below.

Referring back to FIGS. 4 and 5, FIG. 4 illustrates the top portion of the SOW body web page 400 and FIG. 5 illustrate a lower portion of the SOW body web page 400. The portions illustrated in FIGS. 4 and 5 are part of a single web page and the portions of the web page are accessed by the user scrolling through the web page. In another embodiment of the present invention, the template for the entry of information into the body of a statement of work can be divided or separated into several web pages or windows that the user will have to access individually.

If the user is creating a PSOW, the SOW body web page 400 will have a section 404, shown in FIG. 4, for the user to enter or edit information pertaining to the project for which the PSOW was created. Some of the types of project information a user can enter into project information entry section 404 include a project leader, product type, purchase order number, supplier and any other similar type of information that a company designates for inclusion with documents of a project. In one embodiment of the present invention, the project information can be retrieved and entered automatically from a database that is storing project information to simplify the entry of project information for the user. The ability to retrieve and enter project information that has already been entered elsewhere for the project can increase the speed and efficiency of the creation of a PSOW because the user does not have to reenter project information multiple times. The user can then edit and change any project information that has been automatically entered into project information entry section 404 and the project information database is updated to correspond to the changed project information.

In addition, once the user has created an initial PSOW or DSOW and is editing the body of the statement of work from SOW body web page 400, the user will be able to access other options for the PSOW or DSOW from a tab interface 406 (see FIG. 4). By selecting an appropriate tab in the tab interface 406, the user can execute several different options for the current PSOW or DSOW. Typically, when the user initially accesses SOW body web page 400, the user is typically working under tab 408 of the tab interface 406, which is directed to the creating or editing of a statement of work body. The user can also execute an option for attaching optional statement of work descriptions to the sections of the statement of work by selecting tab 410. If the user is working on a blanket statement of work, the user can select tab 412 to add line items to the statement of work. Tab 412 is only displayed and available to a user, when the user is creating or editing a blanket statement of work. The user can select tab 414 to return to the previous web page or screen of the user. For example, the user could return to the project management application or could return to the main page of the SOW application by selecting tab 414. Furthermore, while several different tabs for the tab interface 406 have been described above, other tabs can be included in the tab interface 406. The tabs that can be included in the tab interface 406 can include can be for any function or option that is available for the SOW application. For example, a help tab that provides the user with help information can be included in the tab interface 406.

In a preferred embodiment of the present invention, some of the tabs included in tab interface 406, and in any other tab interface of the SOW application, can be made dependent on the user's particular location in the SOW application or on the user's authorization level. Furthermore, only users with certain authorization levels may be able to access particular features or capabilities in the SOW application. For example and as discussed above, tab 412 is only available in tab interface 406, when the user is working on a blanket statement of work. If the user is working on a standard statement of work, tab 412 is not displayed nor accessible by the user. The availability of other tabs in the tab interfaces of the SOW application can similarly be dependent on specific criteria.

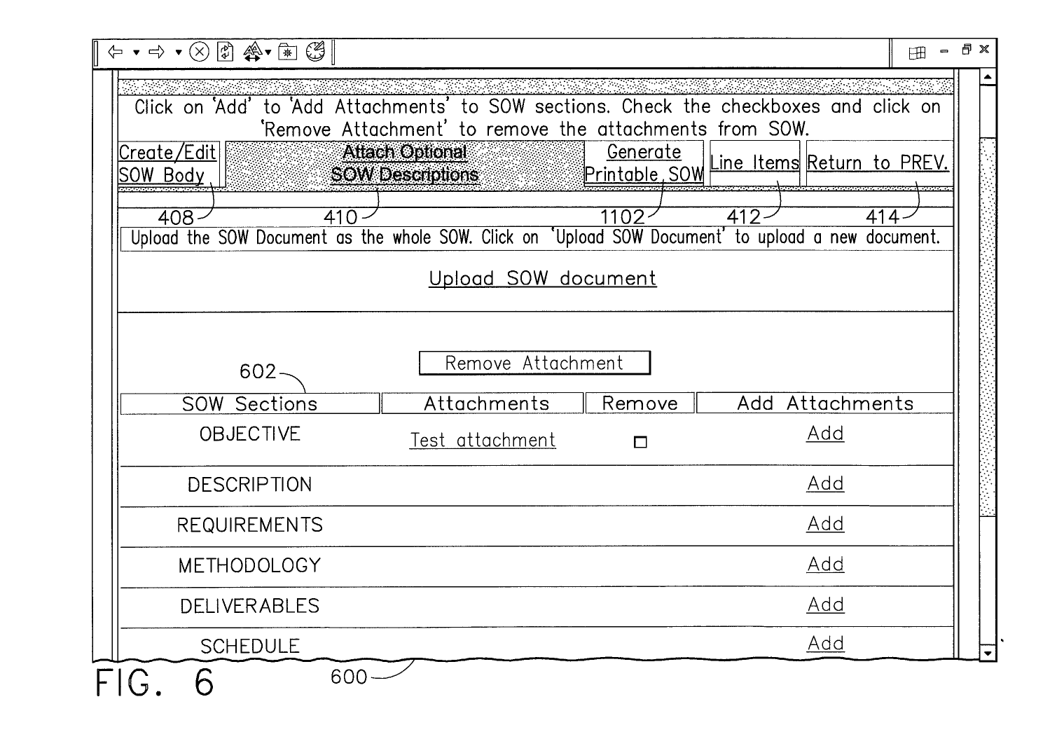

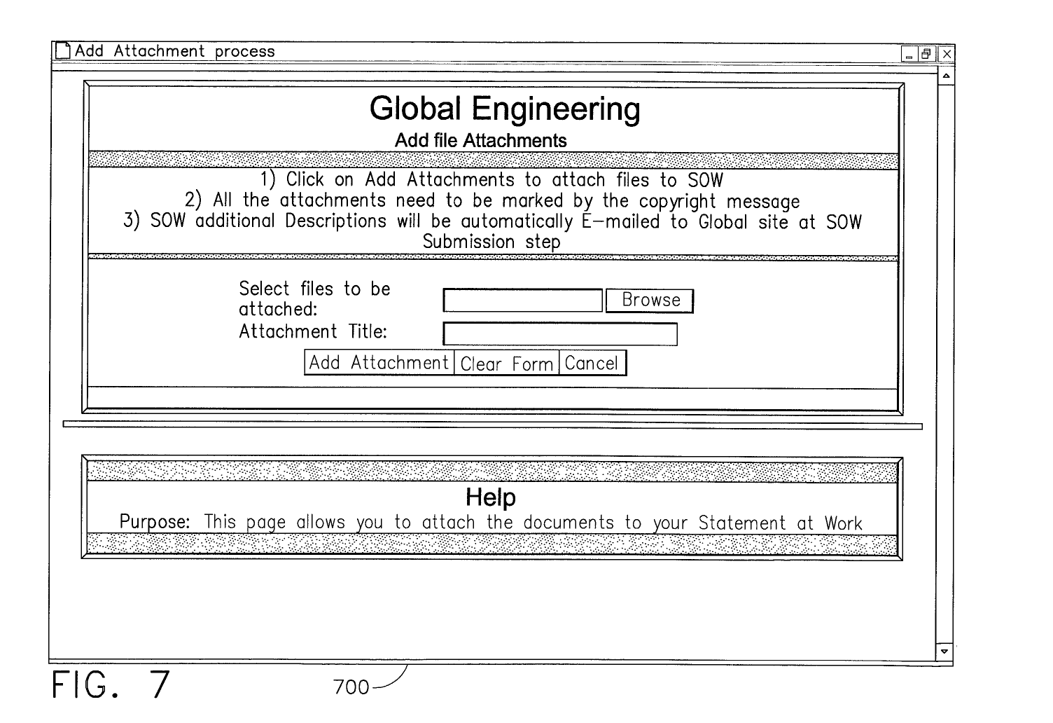

By selecting tab 410 in tab interface 406, the user is connected or linked to a web page or window for adding attachment(s) to the sections or fields 402 forming the body of the PSOW or DSOW being generated by the user. The inclusion of an attachment to a section is typically used to provide additional information or explanation to that particular section of the statement of work. FIG. 6 illustrates an attachments web page 600 for the user to add attachments to the fields 402 of the body of a PSOW or DSOW. On attachments web page 600, an attachments table 602 is presented to the user. The attachments table 602 lists each of the sections 402 that are included in the body of a PSOW or DSOW, lists the attachments currently associated with each of the sections 402 of the PSOW or DSOW and provides the user with the ability to add or remove attachments to the sections 402 of the PSOW or DSOW. When the user selects the option to add an attachment to a section of the PSOW or DSOW, the user is connected to a web page or window for adding attachments. FIG. 7 illustrates an add attachment web page 700 for the user to add files to the PSOW or DSOW. Add attachment web page 700 includes a place for the user to designate the name and location of the files to be attached and to provide a display name for the attached files in the attachments table 602. Once the user enter the files and the display names for the attachments, the user can select the add attachment option and add the files to the PSOW and DSOW, which is then reflected in the attachments table 602 on attachment web page 600.

In another embodiment of the present invention, the attachment web page 600 and the add attachment web page 700 can be combined into a single web page. This single web page would permit a user to add a single file to a statement of work that includes all of the information that would have been included in the multiple files that were previously attached to the statement of work. In still a further embodiment of the present invention, each of the sections on the SOW body web page 400 can include a link which would connect the user directly to the add attachment web page 700 for the user to add attachments directly to the sections 402 of the PSOW or DSOW.

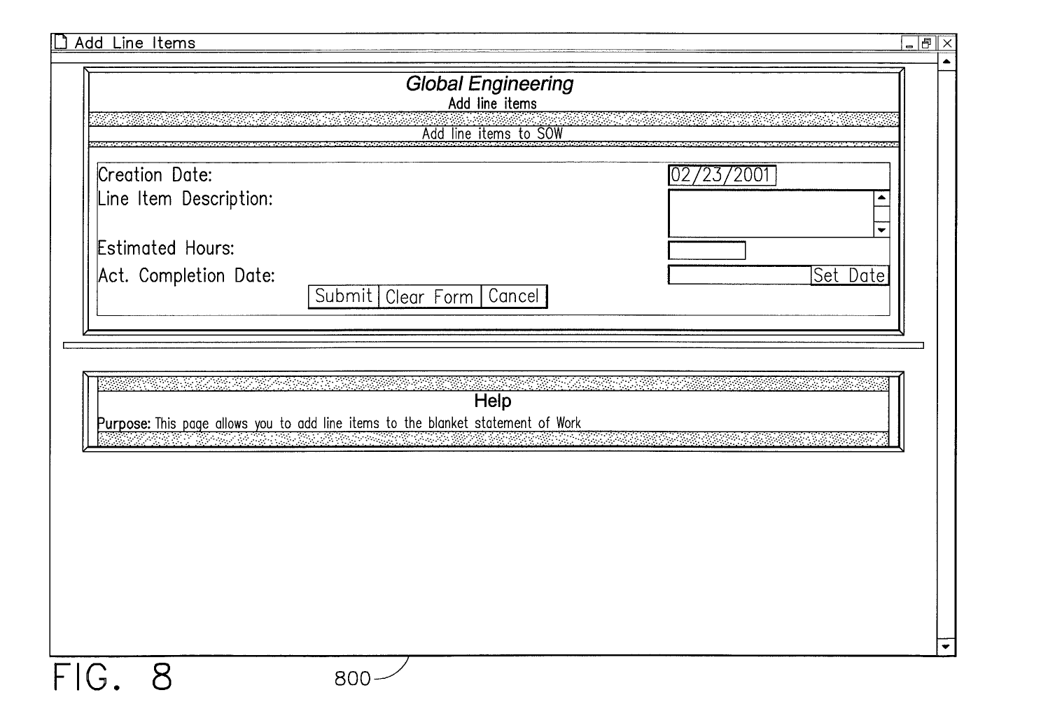

When the user is creating a blanket statement of work, the user can select tab 412 and be linked or connected to a web page for the user to add line items to a blanket statement of work. FIG. 8 illustrates the add line item web page 800 for the user to add line items to a statement of work. The add line item web page 800 includes fields for the user to enter information relating to the creation date of the line item task, the description of the line item task, the estimated hours for completing the line item task and the actual completion date of the line item task. Once the user has entered information relating to the line item in add line item web page 800, the user can then add the line item information to the blanket statement of work. The user can return to the add line item web page 800 as many times as necessary for the user to add all of the line items for the blanket statement of work.

After the user has entered information into the fields 402 of the body of the PSOW or DSOW on SOW body web page 400, added any attachments to fields 402 with attachments web page 600 and add attachments web page 700 and added any line items with add line items web page 800 (if preparing a blanket statement of work), the user can save the PSOW or DSOW to a database(s) associated with the SOW application or the corresponding project of a PSOW. The user can subsequently retrieve the PSOW or DSOW from the database to make further additions, deletions and modifications to the PSOW or DSOW. When the user accesses or retrieves a stored PSOW or DSOW, the user is provided with the tab interface 406 for the user to then select the appropriate tab that corresponds to the desired option or function of the user. The operation of the selected tabs by the user is similar to that described above for the tabs of the tab interface 406.

Once the user is satisfied that all of the necessary information has been entered into a PSOW, the user can the use a submission wizard or routine of the SOW application to provide the PSOW and any attachments or other information to an external source. The user is prevented from using the submission wizard to provide DSOWs to external sources. If the user wants to provide a DSOW to an external source, the user has to associate a project to the DSOW, thereby creating a PSOW which can be provided to an external source.

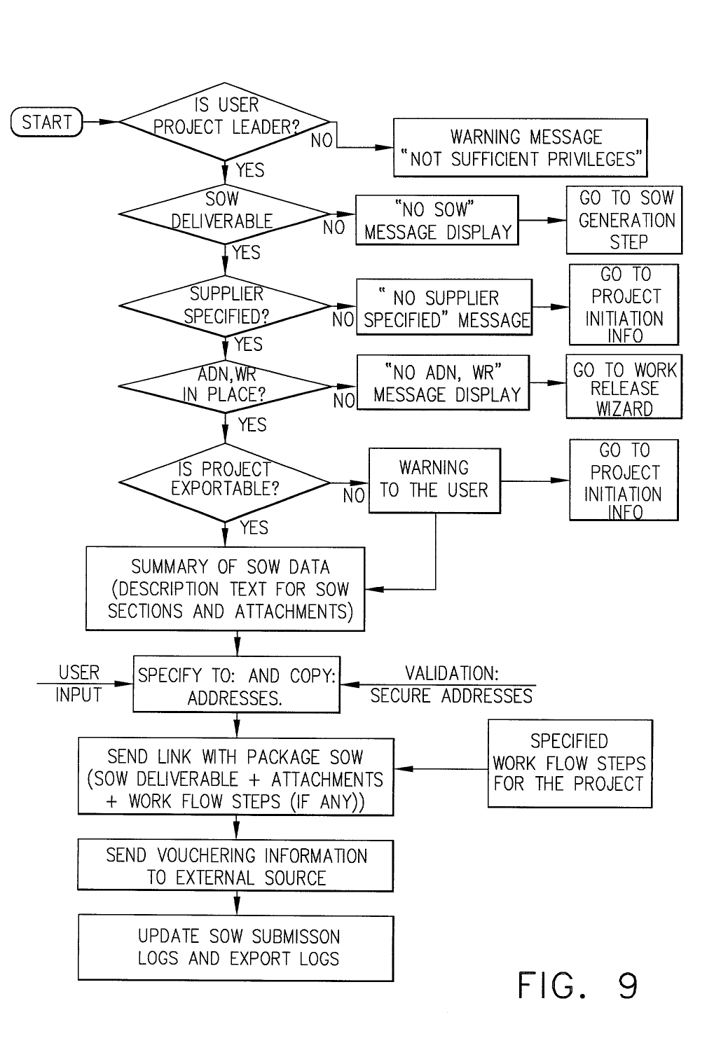

Before a PSOW is provided to an external source the submission wizard of the SOW application completes the process detailed in FIG. 9. This process includes reviews for the appropriate project information and for the inclusion of the appropriate information in the PSOW for the external source. The process begins by confirming that the user has the appropriate authority to send a PSOW to an external source. If the user does not have appropriate authority, the process is stopped and the user is notified that the user does not have sufficient privileges to send a PSOW. The process then confirms that the user has created a PSOW to submit to the external source. If there has been no body of a PSOW that was created, the user is notified and linked to initial PSOW web page 100 to create a new PSOW.

Next, the process confirms that appropriate project information has been provided. The process confirms that an external source or supplier has been designated. If no supplier has been designated, then the user is notified and linked to a web page to provide the supplier information. The process also confirms that appropriate financial information has been provided for the project. Financial information can include a work release number (WR), a purchase order number (PO) and an account distribution number (ADN). If the financial information is incomplete or missing, the user is notified and linked to a web page to enter financial information. The submission wizard of the SOW application then confirms that the PSOW has complied with all export, business and intellectual property controls. The user is provided with a warning if there is a question or conflict on the compliance of the PSOW with export, business and intellectual property controls. After reviewing the warning, the user can attempt to reassess the PSOW in view of the export, business and intellectual property controls or can ignore the warning and continue at the user's own risk.

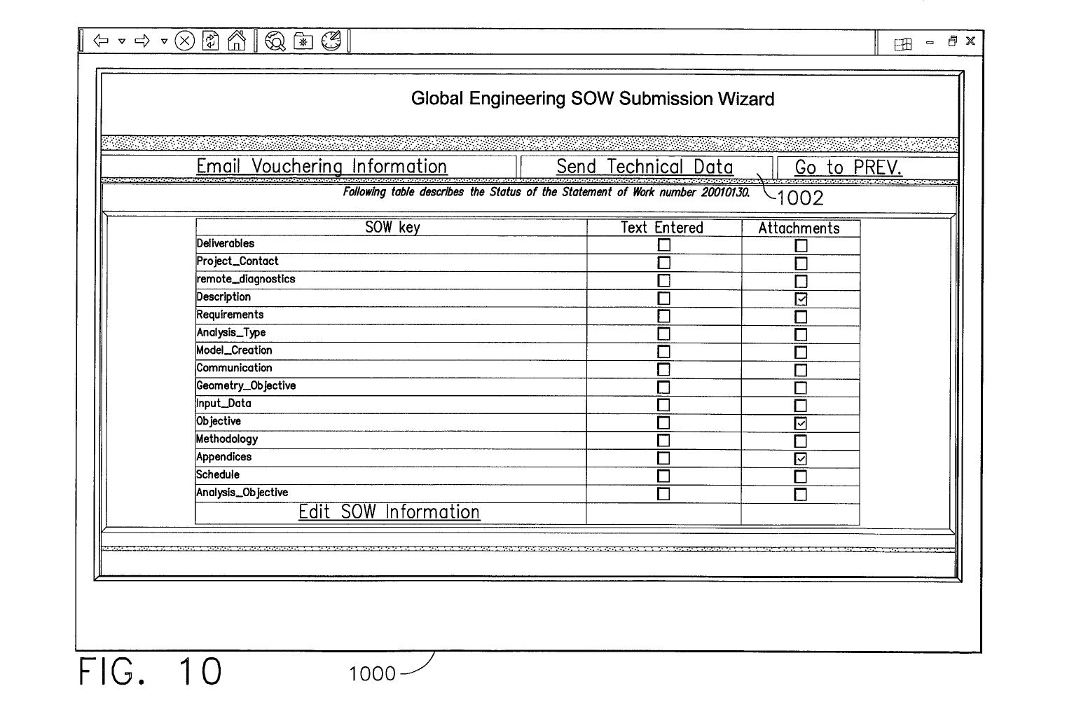

The body of the PSOW is then reviewed to see if all the sections 402 of the body have information entered therein. The submission wizard will then generate a report for the user detailing the review of the body of the PSOW. FIG. 10 illustrates a report web page 1000, which details the results of the submission wizard's review of the information included with the PSOW. Next in the process, the user designates the recipients at the external source and at the user's company and the submission wizard of the SOW application creates a SOW package for delivery to the external source. The SOW package can include the body of the PSOW and any attachments such as work flow steps or additional descriptive material. The designated recipients of the e-mail and the files and information that are included in the SOW package are stored as vouchering information for that e-mail. The submission wizard then transmits an e-mail or other notification with the vouchering information to the designated recipients at the external source, which e-mail or notification has a link to the location of the SOW package. Finally, the SOW application maintains records of the transaction including the logging of the transaction in a SOW submission log and an export log.

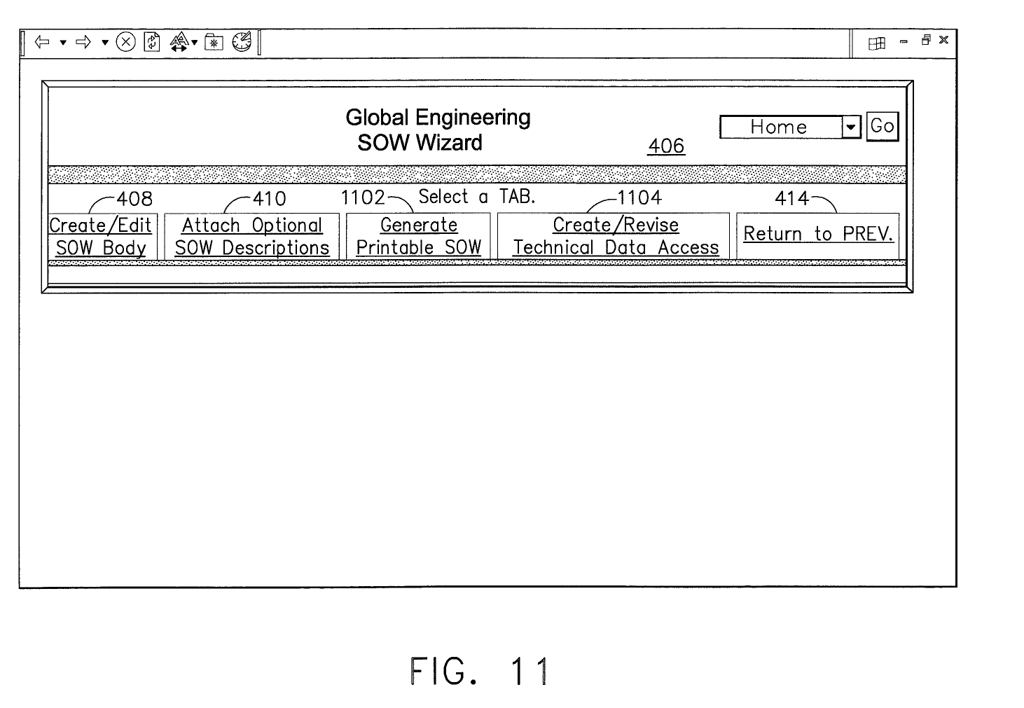

In a preferred embodiment of the present invention, the user can also provide technical data to the external source for use in conjunction with a PSOW. FIG. 11 illustrates a web page with a tab interface 406 for a user to execute a technical data wizard or routine of the SOW application to provide an external source with technical data. The tab interface 406 shown in FIG. 11 is provided to the user after the user has decided to edit an existing PSOW or DSOW with the SOW application. In addition to adding technical data, the user can edit the PSOW or DSOW by selecting tab 408, which connects the user to the SOW body web page 400, or by selecting tab 410, which connects the user to the attachments web page 600. The user can also select tab 1102 to generate a version of the PSOW or DSOW that is suitable for printing.

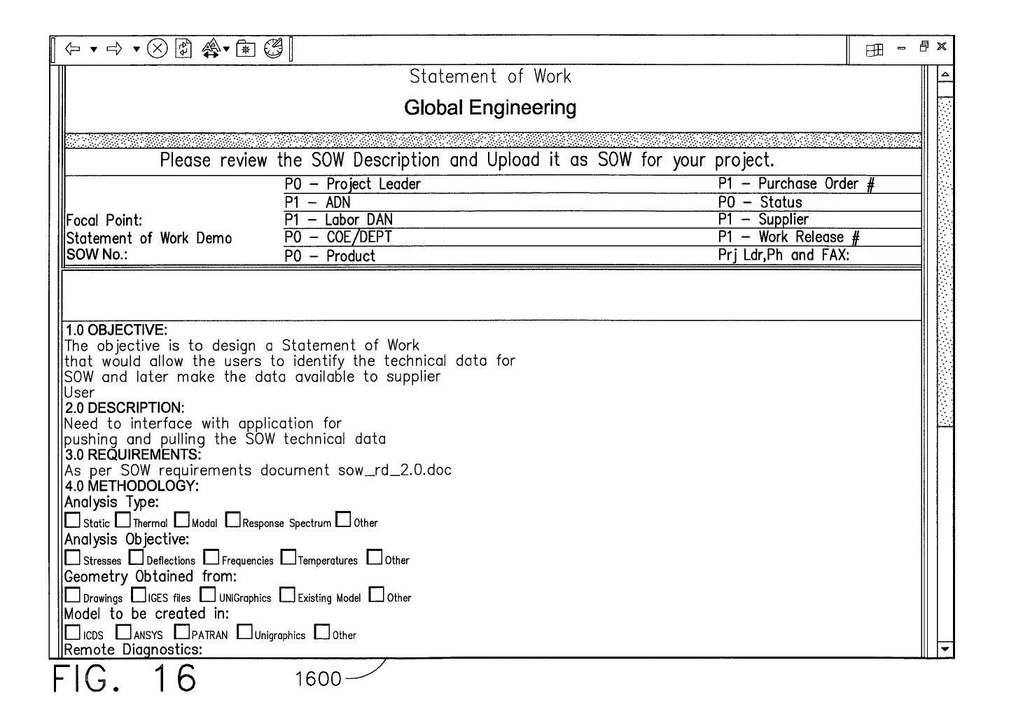

By selecting tab 1102 from the tab interface 406, the user can obtain a printable version of the PSOW or DSOW being worked on by the user. FIG. 16, illustrates a printable statement of work web page 1600. On the printable statement of work web page 1600, any information entered by the user in the SOW body web page 400 and fields 402 has been converted to a format easily printable by the user.

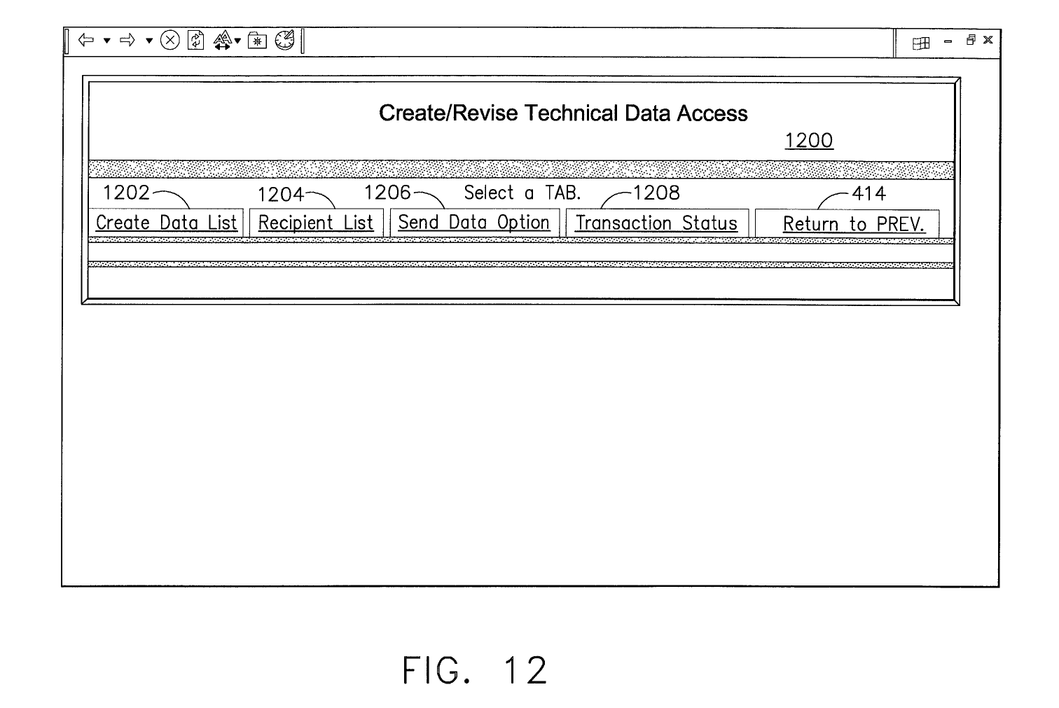

The user would select tab 1104 from the tab interface 406 to be able to provide an external source with access to technical data. Tab 1104 executes the technical data wizard or routine of the SOW application and connects or links the user to a web page or window with a tab interface that has functions associated with operations for technical data. FIG. 12 illustrates the technical data tab interface 1200 that is provided to the user. From the technical data tab interface 1200, the user can create or revise a data list from tab 1202, create or revise a recipient list from tab 1204, provide the technical data to the external source with tab 1206 and can monitor the status of the transactions with tab 1208. The operation of tabs 1202-1208 associated with the technical data wizard will be described in greater detail below.

By selecting tab 1202 the user can create a list of technical data to be sent to the external source or can edit or revise a technical data list if one has been previously created. Before the user can add any files or documents to the technical data list under tab 1202, the user has to ensure compliance with export and intellectual property controls and regulations. In one embodiment of the present invention, the user is linked or connected to a separate web page or window that has an application, wizard or routine that assists the user in determining if export and intellectual property controls and regulations have been complied with by the user. After the user has completed the export and intellectual property review, the user is connected or linked to a web page that permits the user to add, remove and review data items that are to be provided to an external source.

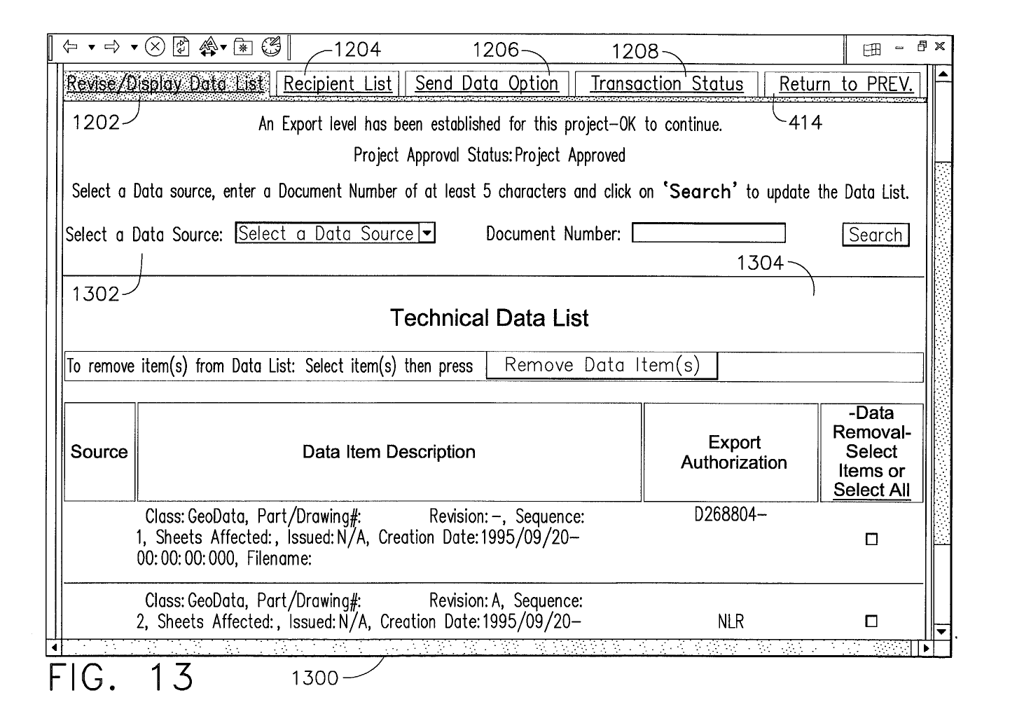

FIG. 13 illustrates the technical data list web page 1300 for the user to add, remove and review technical data items. The technical data list web page 1300 has a search section 1302, that permits the user to search the company's databases and files for the documents and files that the user desires to provide to the external source. The user can review and select files from the search results for addition to a technical data list 1304. The technical data list 1304 lists all the files and documents that are to be provided to the external source for use with the PSOW. The technical data list 1304 provides the user with information on the document or file such as the class, drawing number, revision, etc., and also provides the user with an export or intellectual property classification for the file or document. The user can also select items in the technical data list 1304 for removal and then remove selected items individually or at one time.

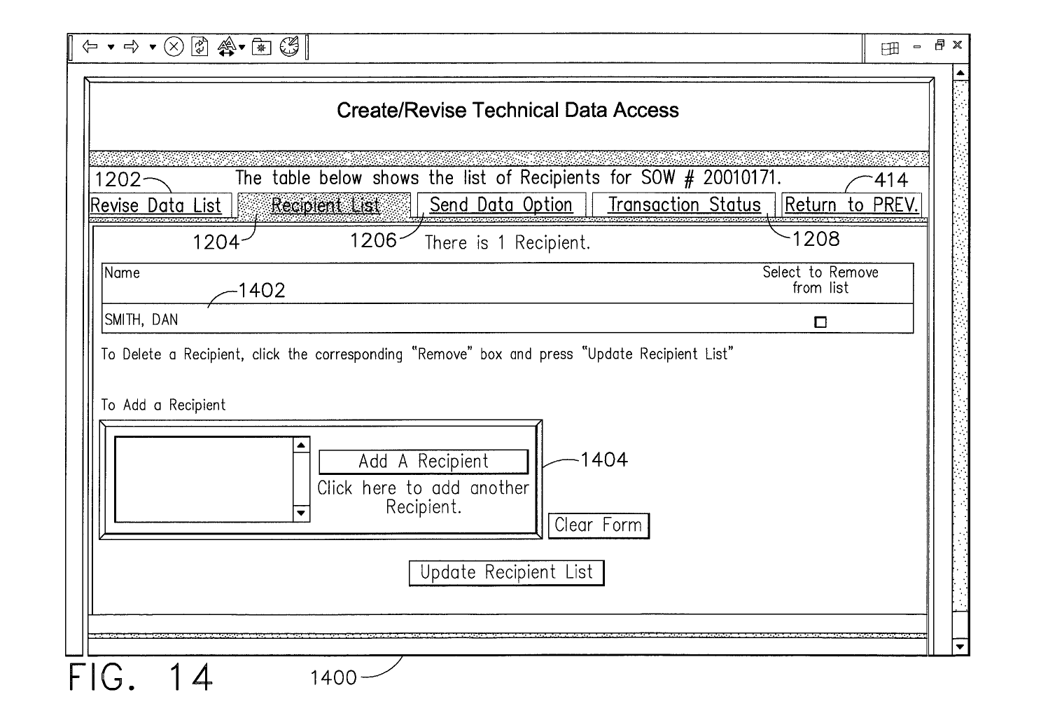

By selecting tab 1204 from the technical data tab interface 1200, the user is connected to a web page or window for creating and revising a recipient list for the technical data. FIG. 14 illustrates a recipient list web page 1400 for the user to create and revise a recipient list for the technical data. The recipient list web page 1400 includes a recipient list 1402 that lists all of the recipients that are to receive the technical data in technical data list 1304. The user can review the recipient list 1402 and remove people from the recipient list 1402 in a manner similar to removing files from the technical data list 1304 as described above. In addition, on recipient list web page 1400, the user is also provided with a search and add recipient section 1404. The search and add recipient section 1404 permits a user to search for recipients of the technical data and then add selected recipients to recipient list 1402. Only users that have appropriate authorization are permitted to add, remove or change the recipients that are included in the recipient list.

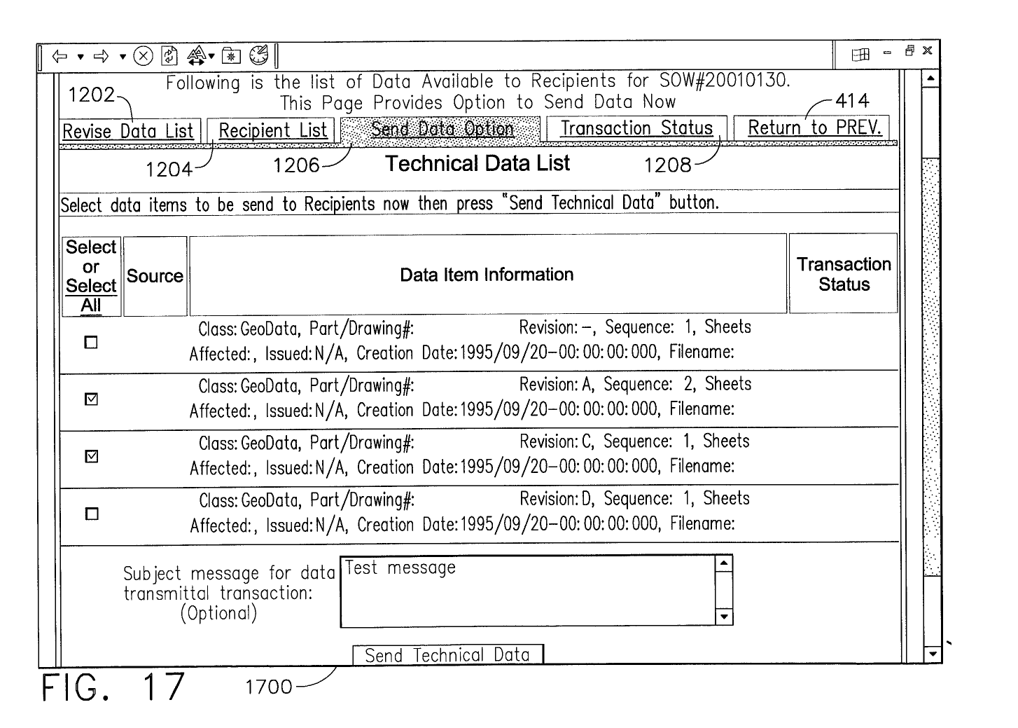

After the user has selected the technical data files and the recipients of the files, the user can provide the technical data to the recipients using tab 1206. The user can also send technical data by selecting tab 1002 from the report web page 1000. FIG. 17 illustrates a send technical information web page 1700 for the user to provide the technical data to an external source. On the send technical information web page 1700, the user is provided with a list of files from the technical data list 1304 and is given the option to send all of the files in the list or only certain selected files from the list. After selecting the files from the list, the user can also add a message for the external source.

In a preferred embodiment of the present invention, the user does not actually send the technical data to the external source, but permits the external source to obtain access to the technical data. The external source is provided access to the technical data files through the company's own computer networks. When the user selects the send technical data option, either through tab 1206 or tab 1002, the user has the technical data files stored at a location where the files can be subsequently accessed by an external source. Once the files are stored at the accessible location, the external source is then notified, preferably by embedded links in an e-mail, of the location of the files. The external source can then access the company's computer network using appropriate security precautions and access and download the technical data files without the need for an explicit transfer of the files by the company. The access and downloading of files by the external source is logged in a file by the SOW application. The PSOW and any corresponding attachments, which may also include technical data, are also preferably provided to the external source in this same manner. In another embodiment of the present invention, the technical data files can be transferred to the external source using e-mail or other similar transfer technology.

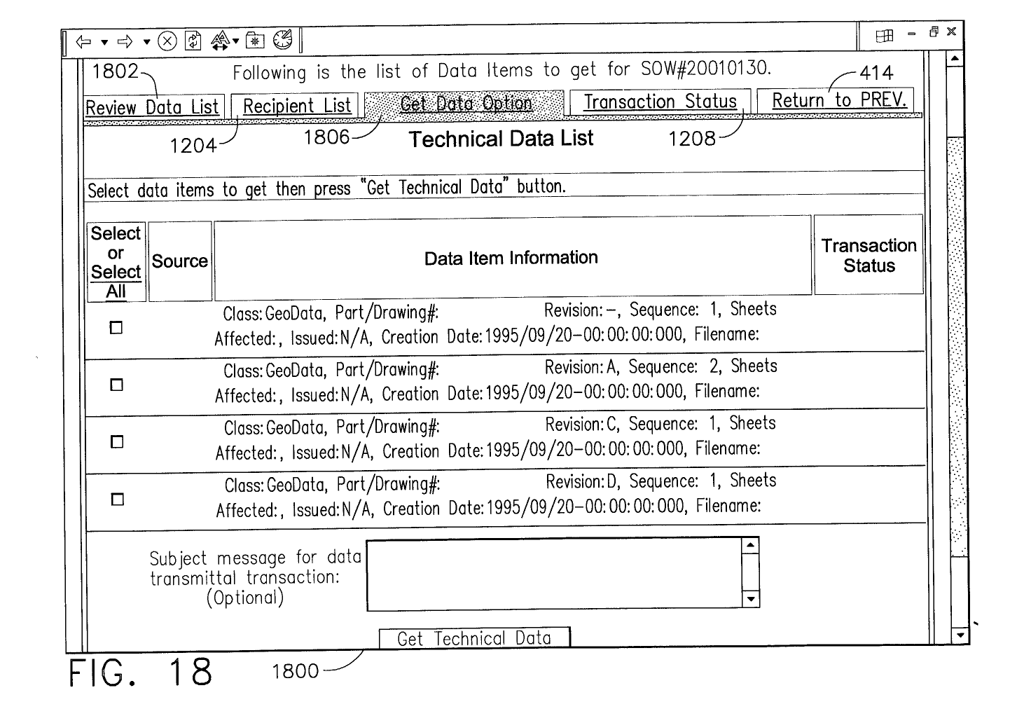

After the external source has been notified on the availability of technical data and has accessed the company's computer network, the external source can begin to retrieve the technical data. FIG. 18 illustrates a get technical data web page 1800 for the external source to obtain the technical data. By selecting tab 1802 from get technical data web page 1800, the external source can review the list of technical data files that were submitted to the external source. In addition, by selecting tab 1806, the external source can retrieve and access the technical data files. If the person at the external source has appropriate authorization, the person at the external source can designate recipients of the retrieved information with tab 1204 and can view the transaction status of the files with tab 1208.

Once the external source has been provided with access to the body of the PSOW, the technical data, and any other files or attachments, the external source can view, use and revise the information and files as necessary. The external source may be assigned a task of completing the body of a statement of work and provided with a template for the statement of work. The external source can access the template for the statement of work directly from the SOW body web page 400 and enter information into the template and submit the completed template back to the user or company. For example, a link provided to the external source can be a link to the SOW body web page 400 that then permits the external source to complete the body of the statement of work. The particular options that are available to an external source, such as creating and revising statements of work, are dependent on the particular authorization and security clearance of the external source and the availability of tabs in the tab interfaces and other options is dependent of the external source's authorization level.

If the user accesses the technical data wizard while working on a DSOW, the user will be prevented from accessing and executing any features available from tab 1206, including send technical data web page 1700. In other words, tab 1206 and send technical data web page 1700 are unavailable for a DSOW. As mentioned above, only PSOWs can be provided to external sources and by preventing a user from accessing the send technical data web page 1700, the user is prevented from being able to provide technical data to an external source under a DSOW.

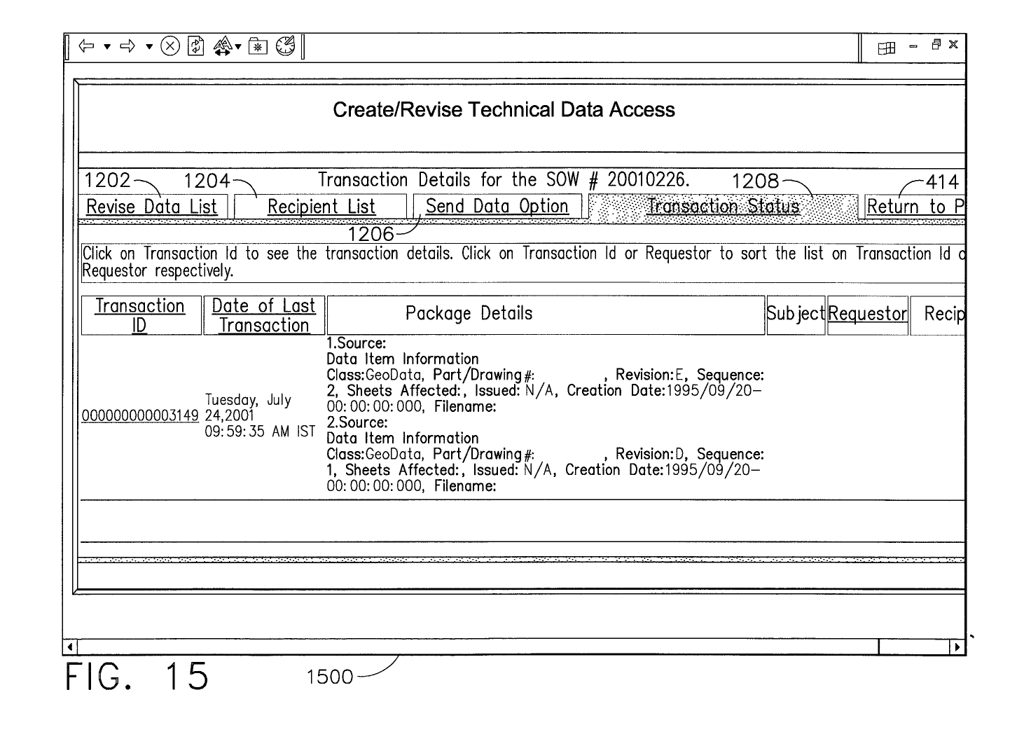

The user can review the status of packages of technical data the user has transferred to external sources by selecting tab 1208 from the technical data tab interface 1200. By selecting tab 1208, the user is linked or connected to the transaction status web page 1500 as shown in FIG. 15. The transaction status web page can provide the user with different information on the packages of technical data that has been provided to external sources. Some of the information included in the transaction status web page 1500, includes the transaction identification, the recipients, the requestor and details on the package including a listing of the files in the package. In addition, the user may be able to access other information on the package of technical data and may have the option to cancel a submission that has not been completed.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is

1. A method of providing a statement of work to an external source, the method comprising the steps of:
creating an initial statement of work in a predetermined format, the predetermined format of the initial statement of work having a plurality of sections;
associating a project for completion by the external source with the initial statement of work;
entering information into at least one section of the plurality of sections of the initial statement of work to generate a project statement of work, the information entered into the initial statement of work pertaining to the project associated with the initial statement of work;
storing the project statement of work in a database;
auditing the project statement of work;
transmitting a link to the external source having a location of the project statement of work in the database; and
accessing, by the external source, the project statement of work with the transmitted link.

2. The method of claim 1 further comprising the steps of:
attaching at least one file to a corresponding section of the plurality of sections, the attached at least one file including additional information pertaining to the corresponding section of the plurality of sections; and
designating technical data for use with the project statement of work.

3. The method of claim 2 further comprising the steps of:
assembling the project statement of work, the attached at least one file and the technical data into a statement of work package;
storing the statement of work package in the database;
transmitting a link to the external source having a location of the statement of work package in the database; and
accessing, by the external source, the statement of work package with the transmitted link.

4. The method of claim 3 wherein the step of accessing, by the external source, the statement of work package with the transmitted link further comprises the steps of:
providing, by the external source, appropriate security authorization to connect to the location of the statement of work package in the database;
viewing at least one of the project statement of work, the attached at least one file and the technical data from the statement of work package in the database; and
downloading at least one of the project statement of work, the attached at least one file and the technical data from the statement of work package in the database to the external source.

5. The method of claim 2 wherein the step of designating technical data further comprises the steps of:
evaluating the project and the external source for export control issues;
generating a list of files having technical data for use with the project statement of work; and
generating a list of recipients at the external source to receive the list of having technical data.

6. The method of claim 1 wherein the step of auditing the project statement of work further comprises the steps of:
checking for authority to transmit the link having the location of the project statement of work to the external source;
checking for inclusion of appropriate project financial information;
checking for compliance with export and intellectual property controls; and
summarizing, in a report, entry of information into each section of the plurality of sections.

7. The method of claim 1 wherein:
the step of creating an initial statement of work further comprises the step of retrieving a previously created statement of work from the database, the previously created statement of work being the initial statement of work, and at least one section of the plurality sections of the previously created statement of work having previously entered information; and
the step of entering information into at least one section of the plurality of sections of the initial statement of work further comprises the steps of:
adding new information into at least one section of the plurality of sections;
deleting previously entered information from the at least one section of the plurality sections of the previously created statement of work; and
modifying previously entered information from the at least one section of the plurality sections of the previously created statement of work.

8. The method of claim 1 further comprising the steps of:
designating the initial statement of work as a blanket statement of work;
adding at least one line item to the blanket statement of work, the at least one line item including a job description and a time estimate.

9. A computer program product embodied on a computer readable medium and executable by a computer for providing a statement of work to an external source, the computer program product comprising computer instructions for executing the steps of:
creating an initial statement of work in a predetermined format, the predetermined format of the initial statement of work having a plurality of sections;
associating a project for completion by the external source with the initial statement of work;
entering information into at least one section of the plurality of sections of the initial statement of work to generate a project statement of work, the information entered into the initial statement of work pertaining to the project associated with the initial statement of work;
storing the project statement of work in a database;
auditing the project statement of work;
transmitting a link to the external source having a location of the project statement of work in the database; and
accessing, by the external source, the project statement of work with the transmitted link.

10. The computer program product of claim 9 further comprising computer instructions for executing the steps of:
attaching at least one file to a corresponding section of the plurality of sections, the attached at least one file including additional information pertaining to the corresponding section of the plurality of sections; and
designating technical data for use with the project statement of work.

11. The computer program product of claim 10 further comprising computer instructions for executing the steps of:
assembling the project statement of work, the attached at least one file and the technical data into a statement of work package;
storing the statement of work package in the database;
transmitting a link to the external source having a location of the statement of work package in the database; and
accessing, by the external source, the statement of work package with the transmitted link.

12. The computer program product of claim 11 wherein the step of accessing, by the external source, the statement of work package with the transmitted link further comprises the steps of:
providing, by the external source, appropriate security authorization to connect to the location of the statement of work package in the database;
viewing at least one of the project statement of work, the attached at least one file and the technical data from the statement of work package in the database; and
downloading at least one of the project statement of work, the attached at least one file and the technical data from the statement of work package in the database to the external source.

13. The computer program product of claim 10 wherein the step of designating technical data further comprises the steps of:
evaluating the project and the external source for export control issues;
generating a list of files having technical data for use with the project statement of work; and
generating a list of recipients at the external source to receive the list of having technical data.

14. The computer program product of claim 9 wherein the step of auditing the project statement of work further comprises the steps of:
checking for authority to transmit the link having the location of the project statement of work to the external source;
checking for inclusion of appropriate project financial information; checking for compliance with export and intellectual property controls; and
summarizing, in a report, entry of information into each section of the plurality of sections.

15. The computer program product of claim 9 wherein:
the step of creating an initial statement of work further comprises the step of retrieving a previously created statement of work from the database, the previously created statement of work being the initial statement of work, and at least one section of the plurality sections of the previously created statement of work having previously entered information; and
the step of entering information into at least one section of the plurality of sections of the initial statement of work further comprises the steps of:
adding new information into at least one section of the plurality of sections;
deleting previously entered information from the at least one section of the plurality sections of the previously created statement of work; and
modifying previously entered information from the at least one section of the plurality sections of the previously created statement of work.

16. A system for providing a statement of work to an external source, the system comprising:
a server computer, the server computer comprising a storage device and a processor;
a statement of work application to provide a statement of work for a project to an external source, the statement of work application being stored in the storage device of the server computer, the statement of work application further comprising:
a database, the database storing information pertaining to the project and the statement of work;
a statement of work template having a predetermined format, the predetermined format of the statement of work template having a plurality of fields, the statement of work template being configured for entry of information into a statement of work for a project;
a submission wizard to evaluate a statement of work for completeness and to provide a statement of work to the external source; and
a technical data wizard to designate technical data associated with a statement of work; and
at least one client computer in communication with said server computer, said statement of work application being accessible on said at least one client computer.

17. The system of claim 16 wherein the statement of work application further comprises:
means for creating a statement of work;
means for storing a statement of work in the database;
means for attaching at least one file to a corresponding field of the plurality of fields of the statement of work template;
means for providing help to a user of the statement of work application; and
means for generating a statement of work formatted for a printer.

18. The system of claim 16 wherein the submission wizard further comprises:
means for evaluating a statement of work for required information and completeness;
means for preparing a report on the evaluated statement of work, the report summarizing a status of entry of information in the statement of work;
means for assembling a statement of work package, the statement of work package including at least one of a project statement of work, at least one attached file and designated technical data; and
means for transmitting a link to the external source, the transmitted link including the location of the statement of work package.

19. The system of claim 16 wherein the technical data wizard further comprises:
means for evaluating a project and external source for export controls;
means for generating a list of technical data items;
means for generating a list of recipients for the technical data items at an external source;
means for sending technical data items to an external source;
means for monitoring a status of a transaction with an external source; and
means for an external source to retrieve technical data items.

20. The system of claim 16 wherein:
the at least one client computer and the server computer are connected by an Intranet;
the means for creating a statement of work further comprises;
means for selecting a type of statement of work, the type of statement of work including a draft statement of work and a project statement of work;
means for selecting a format for a statement of work, the format for a statement of work including a standard statement of work and a blanket statement of work;
means for retrieving a previously created statement of work from the database;
means for associating a project with a statement of work; and
the statement of work template further comprises:
means for entering general project information;
means for loading a statement of work into the statement of work template;
means for adding information to a loaded statement of work;
means for removing information from a loaded statement of work; and
means for revising information in a loaded statement of work.
